(19) United States
(12) Patent Application Publication
(10) Pub. No.: US 2008/0164400 A1
(43) Pub. Date: Jul. 10, 2008

(54) Chainsaw holding apparatus

(76) Inventor: Kelly M. Beechinor, Spokane, WA (US)

Correspondence Address: Randy A. Gregory;Gregory I.P. Law, P.O. Box 31090, Spokane, WA, 99223-3018, US

(21) Appl. No.: 11/651,797

(22) Filed: Jan. 9, 2007

(51) Int. Cl. F16M 13/00; B27B 17/00; A47B 97/00

(52) U.S. Cl. 248/500; 248/316.1; 30/381

(57) ABSTRACT

A chainsaw holder adapted for receiving a chainsaw bar and chain within an interior compartment of a mounting piece. A pressure piece fits at least partly within the interior compartment and is forced by an operator against the chainsaw bar to capture it within the compartment. The operator is adjustable to release the chainsaw bar. The operator may be a screw operator which bears upon the pressure plate. The pressure plate may have an end flange for keeping it positioned within the interior compartment. The mounting piece preferably has flanges which allow fasteners to extend therethrough and secure the apparatus to the side wall of a supporting structure such as the wall of a pickup bed.

### TECHNICAL FIELD

The technical field of this invention is an apparatus for chainsaw storage.

### BACKGROUND OF THE INVENTION

One common practice for transporting a chainsaw is to place the chainsaw in the bed of a pickup, truck, car or the like. This practice does not prevent the chainsaw from rolling over during movement of the vehicle. If a chainsaw rolls over, the fluids usually leak. These fluids are typically gasoline or gasoline and oil mixtures. Also, chainsaws use a heavier oil, typically called bar oil, that is used to lubricate the chain as it moves circuitously around the bar and drive gear. Leakage of such fluids can cause several problems.

One problem that occurs is that when chainsaws are upside down or on their sides they tend to leak the lubricant and fuel and thus create a smelly mess in the back of a pickup or other vehicle. This risk makes it highly undesirable to place chainsaws into the cabins of cars. Even placing them into the trunk of a car is undesirable because of the persistence of the odors and stains which occur from such fluids.

Another type of problem which occurs is that when gasoline and oils are spilt they create a substantial fire hazard. The leakage of gasoline creates fumes which are especially dangerous and considered extremely obnoxious and foul by many people.

Another problem is that if oil leaks it creates not only a mess, but a potential slipping hazard. The oil is thick and sticky and thus is hard to clean up once a chainsaw has tipped and leaked. Thus, a pickup or other truck bed that has bar oil which has leaked thereon can be slippery even if efforts have been made to clean the oil up because of the persistence and difficulty in removing the oil unless volatile and flammable solvents are use heavily or repeatedly. Since chainsaws are very often constantly traveling in a vehicle from one work site to another and often tip or roll over, the leakage can be frequent and the slipping hazard can lead to oil buildup and is usually a constant problem. For example, a pickup bed with or without a liner or of wood will have residual bar oil and a worker can slip when in the bed of the pickup for various reasons. Thus, there has long been a need for eliminating or reducing this risk.

In addition, there is a significant potential for damage to chainsaws and surroundings during travel. A chainsaw is relatively heavy and thus tend to roll easily going around curves, or if oriented across the vehicle then when brakes are applied to stop quickly. Chainsaws are typically constructed of strong materials which are usually heavy and movement of the chainsaw within a moving vehicle is difficult to prevent. Further the chain points are sharp and can damage a vehicle or other contents of the space in which they are being carried. Such makes it capable of doing serious damage. This is particularly true when a vehicle is stopping abruptly or going around sharp corners at relatively high speeds. This places other things positioned adjacent to or in the vicinity of the chainsaw or at risk of being damaged by the chainsaw teeth or by movement of heavy chainsaws.

Current devices used to address some of the above problems and issues associated with chainsaws include plastic slip covers that partially or fully cover the exposed bar and chain. However, such bar and chain covers do nothing to prevent the leakage of fluids nor do they address damage or other problems which occur from rolling of the chainsaw. They do provide some protection to people carrying or near the saw chain. Also they help to protect the bar from minor damage and adjacent things being stowed. However, they do not prevent the chainsaw from improper positioning, rolling or from other objects falling onto the bar and causing it to be bent.

Another approach has been to store a chainsaw inside of a plastic case or box. However, these cases are usually molded plastic with integrated hinges and clasps. This cheap construction is inadequate for long life and durability of the cases. Such cases also frequently do not stay in good shape and must be replaced.

All or most such cases and contained chainsaws are still very susceptible to being overturned when being transported in a vehicle. They are not fluid tight and do not prevent leakage of fuel and bar oil. Even if such boxes or cases were fluid tight, the leakage of fuel and/or oil still will occur if the cases and enclosed chainsaw are overturned. Such fluids then leak within the cases and build up inside and create a greater risk of fire. If the case leaks, as is typical, then the leakage of such fluids from poorly sealed cases cause fuel and bar oil to spread within the vehicle and thus are still a major nuisance when transporting the chainsaws.

Thus, there has long been a need for a better approach to carrying and storing chainsaws. Improving ways of transporting chainsaws is particularly the case when a chainsaw is being moved in a vehicle which travels at high speed or over rough terrain. The current approaches are considered inadequate or unacceptable by many people and thus a chainsaw must be specially stowed, positioned and propped to keep it from rolling and leaking. This is true even when the chainsaw is stored in a full case or when the bar and chain are merely covered by a plastic or other bar and chain cover.

### BRIEF DESCRIPTION OF THE DRAWINGS

Preferred forms, configurations, embodiments and/or diagrams relating to and helping to describe preferred versions of the inventions are explained and characterized herein, often with reference to the accompanying drawings. The drawings and all features shown therein also serve as part of the disclosure of the inventors of the current application. Such drawings are briefly described below.

FIG. 1 is a perspective of a preferred first embodiment according to the inventions. A chainsaw is shown in phantom inserted therein.

FIG. 2 is a front view showing in isolation a frame piece of the embodiment of FIG. 1.

FIG. 3 is a front view showing in isolation a second embodiment of frame piece which can be used in the inventions according hereto.

FIG. 4 is a cross-sectional view taken along line 4-4 of FIG. 1 with the apparatus in an open condition ready to receive a chainsaw bar therein.

FIG. 5 is a cross-sectional view similar to FIG. 4 but with the apparatus in a contracted position for bearing against and holding a chainsaw bar when positioned therein.

FIG. 6 is a perspective of a binding or pressure plate used in the inventions shown in isolation.

FIG. 7 is a side view of the binding or pressure plate in isolation.

### DETAILED DESCRIPTION OF THE PREFERRED EMBODIMENTS

### Introductory Note

The readers of this document should understand that the embodiments described herein may rely on terminology used in any section of this document and other terms readily apparent from the drawings and the language common therefor as may be known in a particular art and such as provided by dictionaries. Widely known are Webster's Third New International Dictionary, The Oxford English Dictionary (Second Edition), and The New Century Dictionary, all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms with one embodiment that may also apply to other embodiments for similar structures, functions, features and aspects of the invention. Wording used in the claims is also descriptive of the invention and the text of both claims and abstract are incorporated by reference into the description entirely in the form as originally filed. Terminology used with one, some or all embodiments may be used for describing and defining the technology and exclusive rights associated therewith.

The readers of this document should further understand that the embodiments described herein may rely on terminology and features used in any section or embodiment shown in this document and other terms readily apparent from the drawings and language common therefor. This document is premised upon using one or more terms or features shown in one embodiment that may also apply to or be combined with other embodiments for similar structures, functions, features and aspects of the invention and provide additional embodiments of the inventions.

### First Embodiment

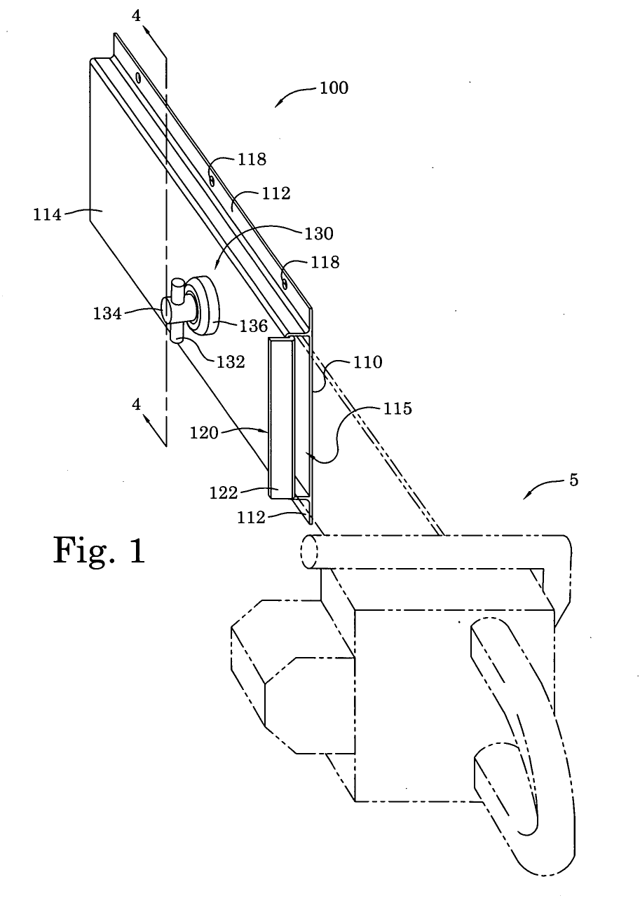

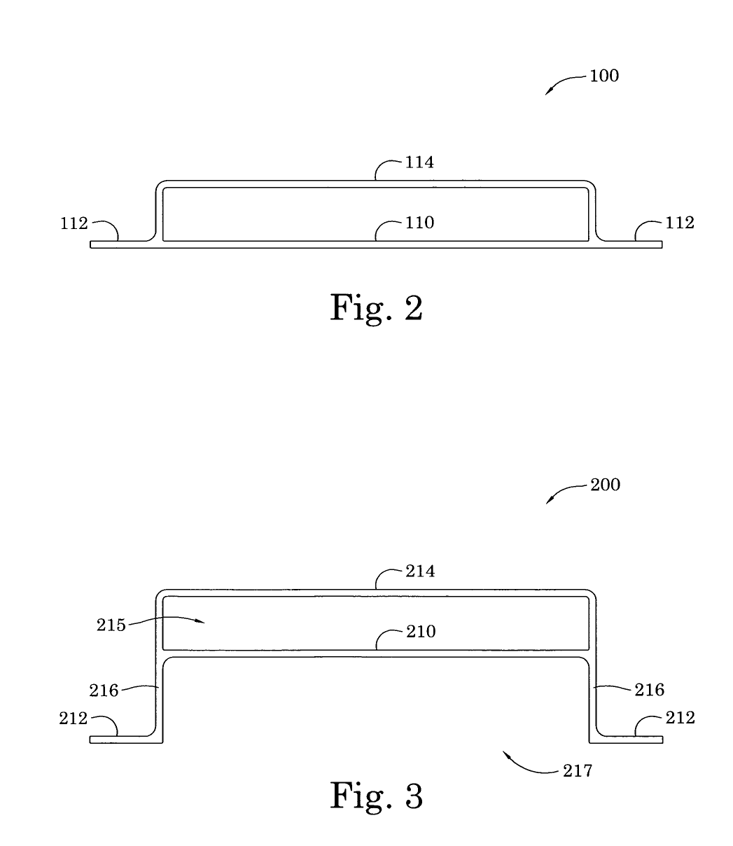

FIG. 1 and others show a first embodiment 100. As shown the first embodiment has a number of features, attributes and aspects which will be described herein. The second embodiment has many of the same features, attributes and aspects and the differences will be explained below. Otherwise the two preferred embodiments are common or similar in features, attributes and aspects.

Main Body Piece

As shown and illustrated, the first embodiment includes a main or body piece. The body piece is constructed to have an interior compartment 115 which is preferably enclosed by the longitudinal walls with the ends open.

As shown, the interior compartment is defined by four walls. The indicated preferred construction includes front wall 114 and back wall 110. Front wall 114 and back wall 110 are connected by edge walls that extend there between. The interior defined between these four walls form the interior compartment 115. In some constructions it may be possible to use a wall to which the apparatus 110 is to be mounted to effectively form a back wall, but which is not part of the main body piece.

The cross-sectional shape of the main body piece is preferably the same along the length of the body piece so that it may be formed in various desired lengths from an extruded piece of suitable material. Suitable materials include metals, plastics and others.

The front wall 114 of the body piece preferably includes a mounting feature for mounting an operator, such as operator 130. As shown, this is done by providing an aperture in the front side wall as most easily seen in FIG. 5. Other configurations for mounting the operator are possible consistent with the inventions taught and shown herein.

Mounting Flanges

The main body piece is preferably mounted in a desired location for ease of use. In one common vehicle, a pickup (not shown) a sidewall or other wall of the pickup storage compartment may advantageously be used to mount the main body piece.

To facilitate easily mounting the apparatus, it has been found desirable to use mounting flanges, such as mounting flanges 112.

Fastening Features

Mounting flanges 112 are preferably provided in an outwardly relationship relative to the main body piece. The mounting flanges 112 are advantageously provided with a suitable means to facilitate mounting of the apparatus to a supporting surface (not shown). The construction illustrated are so adapted by having mounting holes 118 for securing of the apparatus to a supporting surface. This is most easily done by extending sheet metal screws, bolts or other suitable fasteners through the mounting holes and then tightening the mounting flanges and attached body piece to the supporting surface, such as the side wall of a pickup bed or other suitable surface.

Adjustable Retainer Contact

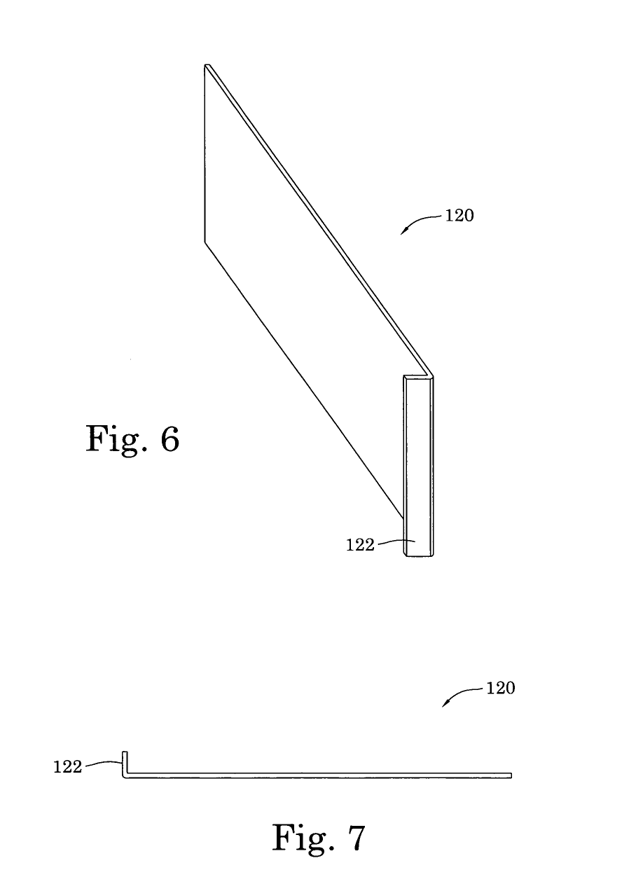

The interior compartment is provided with a contact piece such as retainer contact piece 120. A preferred form of the retainer contact piece is shown in isolation in FIGS. 6 and 7. As shown, the retainer contact is a rectangular piece sized to allow the long portion of the contact piece to be extended into the interior compartment 115.

The retainer contact piece may also advantageously be provided with a head 122. Head 122 is in this embodiment provided with a head that is oriented at an approximately perpendicular angle relative to the long portion of retainer contact piece 120. The head 122 helps to both keep the retainer contact piece in the interior compartment and act as a guide to facilitate insertion of a chainsaw bar into the interior compartment 115. Because the head 122 is typically long enough it is not easily slid through or out of the interior compartment 115. Nonetheless the head helps to guide the chainsaw bar as it is inserted while also giving the operator a surface to handle to keep the retainer contact piece from being removed from the interior compartment when the chainsaw bar is being withdrawn. This is most easily done by simply holding the flanged head 122 with one hand while the other hand of the operator holds onto the handle of the chainsaw and pulls the chainsaw outwardly.

The contact or pressure plate 120 is inserted into compartment 115 with pressure plate flange 122 toward the chainsaw receiving end of the apparatus.

Bar Receiver

The part of interior compartment 115 which is bounded by the back wall 110 and the opposing face of the receiver contact plate 120 form a bar receiver. The bar receiver serves to receive the chainsaw bar therein by inserting the distal end of the chainsaw bar into the interior compartment between the contact plate 120 and back wall 110.

Adjustable Retainer Operator

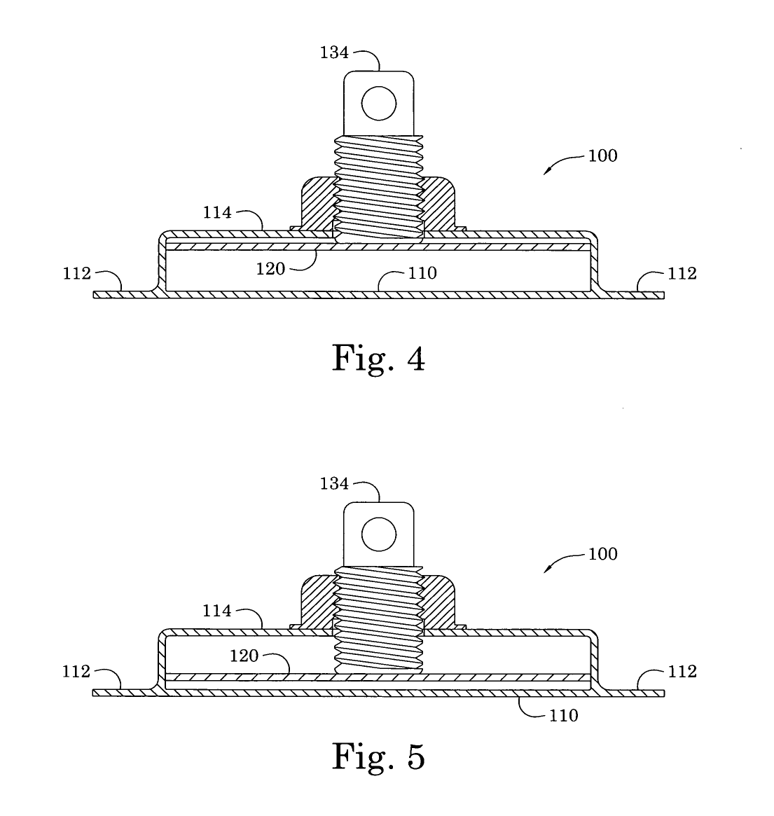

The apparatuses of the inventions include an operator which can be adjusted to help retain the chainsaw bar within the bar receiver. As shown this is done by retainer operator 130. As shown best in FIGS. 1, 4 and 5, retainer operator 130 comprises a boss 136. Boss 136 advantageously includes an inside opening which may be threaded to receive the threaded bolt 134. As bolt 134 is appropriately turned the helical or other suitable threads advance the inside end of the operator bolt 134 through the aperture in front wall 114 and toward the retainer contact piece 120 and back wall 110.

To facilitate operation, operator bolt 134 can be provided with a suitable handle to allow torque to more easily be applied thereto. As shown, this is provided in the form of a hand bar 132. Hand bar 132 can be a cylindrical or other suitably shaped piece that is positioned in and extends through a complementary hole formed in the outer end of the operator bolt 130.

### Second Embodiment

A second embodiment 200 is shown in FIG. 3. The second embodiment is similar to the first embodiment in almost all respects except as noted below. Parts of second embodiment 200 are numbered in a series of numbers starting with two hundred instead of one hundred. Unique to this embodiment are elongated portions 216 of face plate 214.

Apparatus 200 is constructed the same as 100 except it includes extensions 216 which space the interior compartment further from the mounting flanges 212 than the corresponding structure of apparatus 100 wherein the mounting flanges 112 are substantially in the same plane as the back wall 110.

This construction places the mounting flanges 212 such that a compartment 217 is formed to allow various shapes of features of the pickup side wall or other supporting surface to be accommodated. Items which may also be extending into compartment 217 may be fasteners or other things which extend outwardly from the supporting surface between mounting flanges 212. This also positions the chainsaw farther from the supporting surface upon which the apparatus is mounted. Back plate 210 further does not contact the supporting surface. All or substantially all other features and functionalities are similar to the first embodiment and redundant description will not be made.

More about Methods and Manners of Using

The portion of interior compartment 115 between retainer plate 120 and back plate 110 receives the bar and chain portion of chainsaw 5. Retainer operator 130 is tightened by turning operator bolt 134 via hand bar 132, thus rotating the threaded portion of bolt 134 inside the threaded opening of boss 136 to advance the end of bolt against pressure or retainer plate 120. As the retainer contact piece 120 moves toward back wall 110 it engages and applies force and pressure to the chainsaw bar and holds and retains the chainsaw in a secure position with the bar partly or totally enclosed for safety. It also prevents the chainsaw from shifting and causing leakage of fuel or bar oil. Once an adequate binding force has been applied to the chainsaw it will be restricted from coming out.

More about Preferred Manners of Making

The apparatus according hereto are preferably made of a durable material which is sufficiently soft that the hardened steel chainsaw teeth are not dulled by the mere insertion. It has been found that a relatively economical grade of aluminum is appropriately preferred. This preference is due to one or several considerations. The softness of aluminum reduces the risk of dulling the saw teeth during insertion and removal of the chainsaw bar. Such material also can economically be used in an extrusion process to form the main body of the apparatus. Such extrusions can be cut to various lengths for various sizes of chainsaws having differing lengths of bars. Thus the manufacturer can stock a single length of such extrusions and then cut them to the desired length when ordered by a customer.

Similarly, the retaining contact plate is also advantageously made from aluminum to allow easy cutting to size and bending to form the flanged head 122. This also may be done using a strip of stock material which can be cut to the desired length and then the head 122 can be easily bent to form a contact piece 120 which is the desired length for various lengths of main body pieces.

If production of volume of these apparatuses becomes sufficiently large, then it may justify production of the main body and mounting flanges through extrusion of plastic or fiberglass, or by molding. The contact piece 120 may continue to be cut and bent or also can be molded. The threaded boss 136 and operator bolt 134 may also be made from less expensive non-metallic materials or continue to be made from metallic materials such as aluminum or steel for improved strength, toughness and durability.

Other production process may also be found suitable or even preferred whether now known or hereafter developed or improved so that they are appropriate for making apparatuses according to the inventions hereof.

### Further Aspects and Features

The above description has set out various features and aspects of the invention and the preferred embodiments thereof. Such aspects and features may further be defined according to the following claims which may individually or in various combinations help to define the invention.

### Interpretation Note

The inventions shown and described herein have been described in language directed to the current preferred embodiments. Also shown and described with regard to various structural and methodological features. The scope of protection as defined by the claims is not intended to be necessarily limited to the specific sizes, shapes, features or other aspects of the preferred embodiments shown and described. The claimed inventions may be implemented or embodied in other forms while still including the concepts shown and described herein. Also included are equivalents of the inventions which can be made without departing from the scope of concepts properly protected hereby.

I claim:

1. An apparatus for securely holding a chainsaw, comprising:
at least one mounting piece having an interior compartment sized to receive the bar of a chainsaw;
at least one pressure plate with at least portions positioned within said interior compartment of the at least one mounting piece;
at least one adjustable operator connected to the at least one mounting piece with at least one actuator that can be adjusted to apply force to the pressure plate to move it within the interior compartment for clamping a chainsaw bar between the at least one pressure plate and said interior compartment.

2. An apparatus according to claim 1 further comprising at least one mounting flange connected to the at least one mounting piece for use in mounting the apparatus to a supporting structure.

3. An apparatus according to claim 1 further comprising at least one mounting flange connected to the at least one mounting piece for use in mounting the apparatus to a supporting structure and wherein the at least one mounting flange include apertures through which the apparatus can be mounted using at least one suitable fastener.

4. An apparatus according to claim 1 wherein the at least one mounting piece is constructed to have a fully enclosed interior compartment.

5. An apparatus according to claim 1 further comprising at least one mounting flange connected to the at least one mounting piece for use in mounting the apparatus to a supporting structure, said at least one mounting flange having extensions to stand the interior compartment away from a supporting surface.

6. An apparatus according to claim 1 wherein the at least one adjustable operator is a threaded operator that forces the pressure plate against the chainsaw bar.

7. An apparatus according to claim 1 wherein said pressure piece has an end flange to help retain the pressure piece within the interior compartment.
